(19) United States
(12) Patent Application Publication
(10) Pub. No.: US 2006/0221617 A1
(43) Pub. Date: Oct. 5, 2006

(54) LED night light with liquid optics medium

(76) Inventor: Tseng-Lu Chien, Taipei Hseng (TW)

Correspondence Address: BACON & THOMAS, PLLC, 625 SLATERS LANE, FOURTH FLOOR, ALEXANDRIA, VA, 22314, US

(21) Appl. No.: 11/094,215

(22) Filed: Mar. 31, 2005

(51) Int. Cl. F21V 3/00

(52) U.S. Cl. 362/311

(57) ABSTRACT

The LED night light with liquid optics medium arrangement to let visible wavelength light beam passing though the said liquid optics medium to viewer. The liquid optics medium with miniature means can be selected from group combination from textile, metal, plastic, porcelain, ceramic, dry flower, wood, plants, potpourri in the shape of toys, stuff toys, blow-mold unit, season items, dolls, porcelain unit, ceramic units, poly resin unit, sporting related unit, painting unit, poster unit, sign unit, photo unit, angels unit, artificial related unit, animal unit, flower unit or the conventional units for variety gift, toy, sports, seasonal, holiday applications to make the said night light with more attractive light effects. The night light further incorporated with heater element to make the liquid medium with heat stream flow to make movement of the inner miniatures means of liquid medium to increase the motional night light than other LED night light only light beams changeable lack of the motion miniatures means.

### BACKGROUND

This application is related to the July 2004, Fiber Optic light kits for footwear Ser. Nos. 10/883,747 and 10/954,189 and 10/667,787 and 10/286,871 and co-pending filing for the “Multiple function wall cover plate”, “Multiple function night light”, “Fiber Optics night light”, “Linear tube night light with changeable light patterns”.

The co-inventor's prior arts U.S. Pat. No. 5,926,440, U.S. Pat. No. 6,158,868, U.S. Pat. No. 6,170,958, U.S. Pat. No. 6,171,117, U.S. Pat. No. 6,280,053 disclosure arrangement for the conductive means for night light and multiple functions night light incorporated with time piece. The other U.S. Pat. Nos. 4,947,291, 5,495,402, 5,662,408, 5,713,655, 5,803,579, 5,816,682, 5,833,350, 5,893,626, 5,998,928, 6,000,807, 6,010,228, 6,031,958, 6,033,087, 6,056,420, 6,132,072, 6,160,948, 6,161,910, 6,183,101, 6,190,017, 6,290,368, 6,337,946, 6,386,730, 6,390,647, 6,00,104, 6,411,524, 6,431,719, 6,509,832, 6,523,976, 6,550,949, 6,609,812, 6,623,416, 6,641,289, 6,648,496, 6,709,126, 5,803,579, 6,033,087, 6,031,958, 6,161,910, 6,24,273, 6,280,051, 6,431,719, 6,561,677, 6,648,496, 6,709,126, 6,811,281 show all the different light source and application but there is no one teach the LED night light incorporated with the liquid optics medium and its miniatures means to create medium means with motion and optics properties including reflective, deflective, random etc by miniatures means within the medium means. The US prior art U.S. Pat. No. 6,709,126 disclosure a LED night light with a rotating base with 2 LED light means (80) install to let the people directly to see the LED light beam. The US prior art U.S. Pat. No. 6,648,496 have one LED install on 4 corners of the cover plate with focusing features. US prior art U.S. Pat. No. 6,431,719 to arrange LED behind a translucent lens and let people directly to see the LEDs light beams with out of date 3 pcs LED array for light means. The space-art LED can only use one single piece to make the multiple color of spectral output for cost and spacing saving consideration. The current invention having the LEDs as light means incorporating the liquid optics medium to make LED light beam in-directly to view with optics properties with suspended miniature means therein. These features and details construction and light arrangement to viewer is totally different with the '719 spirit and coverage.

From the US prior art U.S. Pat. No. 6,431,719 which disclosure are different with current invention from the comparison below.

(C1) The night light with 3pcs LEDs as light source with R/G/B colors with continuously changing patterns of differently color light while the prong means connected with light source. This is only one function functions from the current invention. The current invention has the plurality of functions build inside the circuit means. The said night light connect with power source will have the 1^{st} light function and can be change to the other function while use the switch means to select from the plurality of the functions and stay the next function till to reset.

(C2) The '179 patent teach to use several piece of LEDs (30) (column 2, line 6-7) and “The three separated LEDs (Column 2, line 40-45), “The three LEDs are series connected . . . ” (Column 2, line 48-51). All these technical is out of date and need too big space for arrangement. The current invention prefer to use a single LED with different color dices inside to save the space and cost for the application to fit into the limited night light's housing.

(C3) The light beam be seen from viewer of current invention are passing thoug the medium means with light path with reflective, deflective, diffusion, random by the medium material and suspended miniature means' surface so the visible light beam is more changeable especially incorporated with heater means will cause the liquid with flow stream effects will increase more eye-catching effects.

(C4) the current invention the LEDs is not visible directly from viewer. The viewer only see the in-directly light beam though the medium means.

From the US prior art U.S. Pat. No. 6,648,496 with same LED light functions with '719 but the application on the wall cover plate for different categories. The US prior art U.S. Pat. No. 6,709,126 with the rotating base and LED light arrangement on the post but still directly to see the light is similar with '719 but with other features.

The LED night light with liquid optics medium can let visible wavelength light beams to be seen by viewer though the said miniature means arranged within the liquid optics medium so can create a splendid light effects and value appearance of the said night light. The motion effects of the miniature means caused by current invention by adding a heater element near the bottom of the medium means. The heater means can make by (h1) resistor (b2) printing circuit board with conductive path from narrow to wide to cause the electricity passing though from small to higher to make from cold to higher temperature. The heater means are located under, attached to the medium means to cause the medium means to create flow or stream to let miniature means make movement.

The miniatures means are within the said medium media which may be any material such as (mi 1) shell, (mi 2) leaves, (mi 3) dry flower, (mi 4) potpourri, (mi 5) flower, (mi 6) plastic piece, (mi 7) floating stuff, (mi 8) fish, (mi 9) animals, (mi 10) smiling face, (mi 11) metal piece, (mi 12) paper piece, (mi 13) wood piece, (mi 14) seed, (mi 15) boat, (mi 16)snow flake, (mi 17)tree, or (mi 18) any material with designed shape and colors with design, indicia, drawing, color, painting, coating which available to put within the medium means to increase the value appearance to let the medium means look like conventional gift items which including a scene inside such as seasonal water ball, artificial aquarium, kids toy with sealed liquid applications.

The medium means which may selected from group combination from (m1) Oil, (m2) solid plastic body, (m3) light passing though material, or (m4) any medium means which have desired gravity, viscosity, density which can cause the light have reflective, diffusion, optics properties may incorporate with the said LED light source to increase the value, appearance, accent of the said night light.

The night light's configuration and shape may be selected from group combination from the toy, gift, souvenir, seasonal unit, holiday unit, painting, poster, sign, photo, artificial flower, doll, porcelain unit, ceramic unit, viscous-mud related unit, blow-mold unit, stuff toys unit, promotion unit or any conventional unit on market place.

The LED night light also can be properly arranged to as a stencil, indicia, front sheet, cover piece, outside appearance piece with LED light means arranged to created the expected light effects. The LED light means add the liquid optics medium means, miniature means and its related multiple functions' circuit will increase the light effects while the said night light's prong to insert into the wall outlet receptacle.

The LED night light with liquid optics medium may incorporated the proper circuit means which can have the (f1) steady, (f2) chasing, (f3) random, (f4) fade in and fade out, (f5) sequential, (f6) pair flashing, (f7) scan, (f8) color mixed, (f9) color changing, (f10) all flashing or (f11) any combinations for all light effects from market place available. All these functions can be designed under predetermined time, duration, orders, and function as requirement.

The LED night light with liquid optics medium may incorporated the other electric device such as (o1) motor, (o2) movement, (o3) filter device, (o4) IC chips with desired functions, (o5) sensor, (o6) rotating filter to make preferable light effects and functions.

The LED light means may be selected from the group combination from the dice, chip, sealed unit of the LED depend on the space limitation and functions needed with related circuit means and control means to make the proper illumination with desired functions and effects.

The LED light beams pass though the said liquid optics medium with visible wavelength to viewer to get the plurality of light patterns effects while prong means are connected with power source. The features to have the LED multiple functions light beams incorporated with heater means to make the liquid optics medium means and miniatures means to have motion effects to increase the said night light value and appearance for building, moving transportation equipment with proper prong means.

### DRAWING

FIG. 1A: Disclosure the prior art with LED light means.

FIG. 1B: Disclosure the prior art with Bulb light means and liquid container.

FIG. 1 and 1C: Disclosure the 1^{st} embodiment for the current invention.

FIG. 2 and 2A: Disclosure the 1^{st} embodiment of LED night light with liquid optics medium and heater means.

FIG. 3 and 3A: Disclosure the 1^{st} embodiment of LED night light with liquid optics medium and heater means having the heat holes.

FIG. 4: Disclosure the 1^{st} embodiment of LED night light with liquid optics medium and its details constructions.

FIG. 5: Disclosure the details of 2^{nd} embodiment of LED night light with liquid optics medium in a C7 size bulb shape with build-in liquid optics medium arrangement.

FIG. 6: Disclosure the 3^{rd} embodiment of LED night light with liquid optics medium which have incorporated with time piece movement and magnetic means on the miniature means base and time piece's second arm to make the miniature means moved each second within the liquid medium. The center area of the liquid medium container is clear so can see the minutes and hour arms though the medium container center areas. The LEDs can be arranged on the dial face for the 3,6,9,12 with precisely location for illumination as night light or more position from 1 to 12 locations.

FIG. 7: Disclosure the Oriental adjustable LED light kits with oriental adjustable with its base.

FIG. 8: Disclosure the Oriental adjustable LED light kits with 360 degree adjustable features with plurality of ball joint means.

FIG. 9: Disclosure the Night light with build in LED light kits with desired oriental adjustable features.

FIG. 10: Disclosure the LED night light construction with rigid optical medium to make light arrangement with front metal stencil piece with plurality of LEDs to get desired light color change with functions changing from circuit means.

### DETAILED DESCRIPTION

The LED night light with liquid optics medium including (A) prong means, (B) circuit means, (C) LED light means, (D) medium means, (E) heater means, (F) housing further optional to selected the (F) miniature means, (G) other device(s), to make the splendid light performance and let the light beams pass though the medium means with optics properties to be seen by viewer. The LED light beams pass though the said liquid optics medium with visible wavelength to viewer to get the plurality of light patterns effects while prong means are connected with power source. The features to have the LED multiple functions light beams incorporated with heater means to make the liquid optics medium means and miniatures means to have motion effects to increase the said night light value and appearance for building, moving transportation equipment with proper prong means.

The said light means is a space-art and new LED which only have single piece of unit with build in dices of different color with IC control to make different light functions. The LED light means may be selected from the group combination from the dice, chip, sealed unit of the LED depend on the space limitation and functions needed with related circuit means and control means to make the proper illumination with desired functions and effects.

The LED night light with liquid optics medium may incorporated the proper circuit means which can have desired function may selected from the group combination from (f1) steady, (f2) chasing, (f3) random, (f4) fade in and fade out, (f5) sequential, (f6) pair flashing, (f7) scan, (f8) color mixed, (f9) color changing, (f10) all flashing or (f11) any combinations for all light effects from market place available. All these functions can be designed under predetermined time, duration, orders, and function as requirement. All these preferable functions are build-in the said circuit means which can be selected by a control means. The said night light Have the 1^{st} light function and can be change to the other function by control means.

The said medium means which may selected from group combination from (m1) Oil, (m2) solid plastic body, (m3) light passing though material, or (m4) any medium means which have desired gravity, viscosity, density which can cause the light have r

The miniatures means are within the said medium media which may be any material such as (mi 1) shell, (mi 2) leaves, (mi 3) dry flower, (mi 4) potpourri, (mi 5) flower, (mi 6) plastic piece, (mi 7) floating stuff, (mi 8) fish, (mi 9) animals, (mi 10) smiling face, (mi 11) metal piece, (mi 12) paper piece, (mi 13) wood piece, (mi 14) seed, (mi 15) boat, (mi 16)snow flake, (mi 17)tree, or (mi 18) any material with designed shape and colors with design, indicia, drawing, color, painting, coating which available to put within the medium means to increase the value appearance to let the medium means look like conventional gift items which including a scene inside such as seasonal water ball, artificial aquarium, kids toy with sealed liquid applications. eflective, diffusion, optics properties may incorporate with the said LED light source to increase the value, appearance, accent of the said night light.

The night light's configuration and shape may be selected from group combination from the toy, gift, souvenir, seasonal unit, holiday unit, painting, poster, sign, photo, artificial flower, doll, porcelain unit, ceramic unit, viscous-mud related unit, blow-mold unit, stuff toys unit, promotion unit or any conventional unit on market place.

The LED night light with liquid optics medium may incorporated the other device such as (o1) motor, (o2) movement, (o3) filter device, (o4) IC chips with desired functions, (o5) sensor, (o6) rotating filter to make preferable light effects and functions.

The motion effects of the miniature means caused by current invention by adding a heater element near or adjacent to the bottom of the medium means. The heater means can make by (h1) resistor (h2) printing circuit board with conductive path from narrow to wide to cause the electricity passing though from small to higher to make from cold to higher temperature. The heater means are located under, attached to the medium means to cause the medium means to create flow or stream to let miniature means make movement.

From the US prior art U.S. Pat. No. 6,431,719 which disclosure are different with current invention from the comparison below.

(C1) The night light with 3 pcs LEDs as light source with R/G/B colors with continuously changing patterns of differently color light while the prong means connected with light source. This is only one function functions from the current invention. The current invention has the plurality of functions build inside the circuit means. The said night light connect with power source will have the 1^{st} light function and can be change to the other function while use the switch means to select from the plurality of the functions and stay the next function till to reset.

(C2) The '179 patent teach to use several piece of LEDs (30) (column 2, line 6-7) and “The three separated LEDs (Column 2, line 40-45), “The three LEDs are series connected . . . ” (Column 2, line 48-51). All these technical is out of date and need too big space for arrangement. The current invention prefer to use a single LED with different color dices inside to save the space and cost for the application to fit into the limited night light's housing.

(C3) The light beam be seen from viewer of current invention are passing thoug the medium means with light path with reflective, deflective, diffusion, random by the medium material and suspended miniature means' surface so the visible light beam is more changeable especially incorporated with heater means will cause the liquid with flow stream effects will increase more eye-catching effects.

(C4) the current invention the LEDs is not visible directly from viewer. The viewer only see the in-directly light beam though the medium means.

From the US prior art U.S. Pat. No. 6,648,496 with same LED light functions with '719 but the application on the wall cover plate for different categories. The US prior art U.S. Pat. No. 6,709,126 with the rotating base and LED light arrangement on the post but still directly to see the light is similar with '719 but with other features.

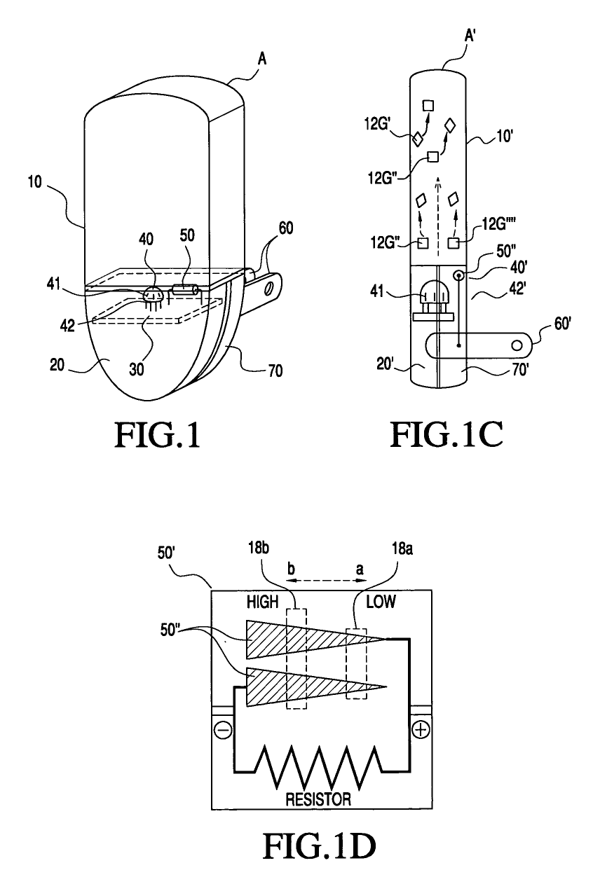

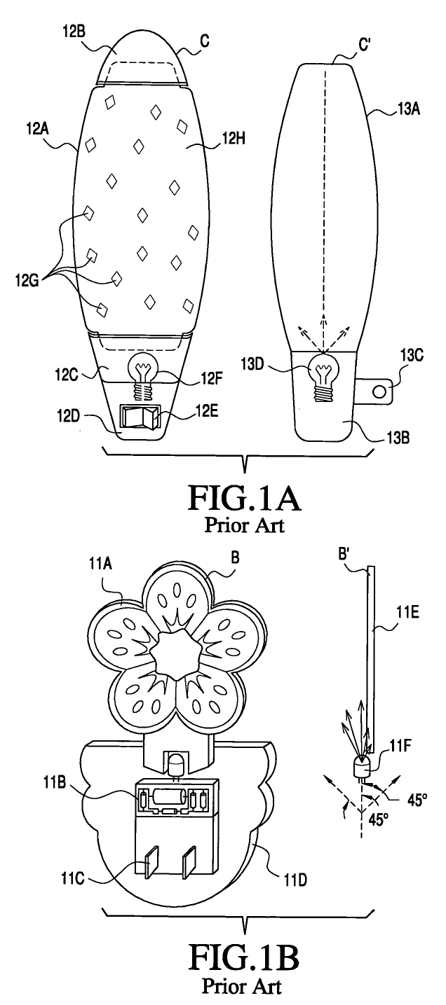

From the FIG. 1A, disclosure the prior art the bulb night light (C) has a bulb (12F) below the medium means (12H) which have the heat created from the filament bulb (12F) with a switch (12D) to turn on the bulb on and off. This prior art do not have the multiple functions light effects and just turn on and turn off the bulb. From the embodiment (C′) can see the construction of this prior art. This prior art lack of the multiple color or multiple functions of the light beams.

From the FIG. 1B, disclosure the prior art the LED night light (B) has the upper plastic piece with very thin material so can have lower cost for this plastic stencil. A LED light means on a circuit means (11B) with prong means (11C) install on the said circuit means to get power to the said circuit means has single light color output and single function. Also, the embodiment (B′) is lack of the eye-catching light effects because the LED (11F) is bigger than the plastic piece (11E) and majority of light beams are wasted so the light effects is very bad than current invention.

From FIG. 1, disclosure a 1^{st} embodiment of the LED night light (A) have the upper housing (10) and front base (20) and back base (70) with prong means (60) extend from rear surface of the back base (70). A single LED light means (40) are install on the circuit means (30) with at least 3 dices inside the LED body to allow the multiple color light beam emit out from the said LED light means while the circuit means (30) offer the proper electric signals to the said LED. A heater means (50) disposed within the housing space which have the certain temperature on the heat means surface while the electricity pass though the said heat means. It can be connected with prong means in parallel connection and do not have any relation with the circuit means as individual heat function. From FIG. 1 and FIG. 1D, The heat means (50) as earlier discussion can be in the form of the printing circuit board (hereafter as PCB) (50′) with pre-designed narrow to wider path (50″) to make the electric current pass from small current to bigger current and cause the said heat means with lower to higher temperature the movable conductive element (18A) can be move from position (a) to (b) so the current cross the conductive element (18A) will have small current to bigger current and cause the resistor have lower to higher temperature. The heat means (50′) connect with prong means on the position (+) and (−) with super thin space requirement because PCB is very thin.

From the FIG. 1C, The side view of the FIG. 1 disclosure the night light (A′) with the top housing (10′) and the front base (20′) and back base (70′) with the heat means (50″) parallel connected with the prong means (60′) to have the heat temperature to upper space. The heat air will let the upper housing bottom with heat to cause the inner medium means (not shown) and miniatures means (12G′) (12G″) (12G′″) (12G″″) to be moved. The preferred medium means and miniatures means as earlier discussion.

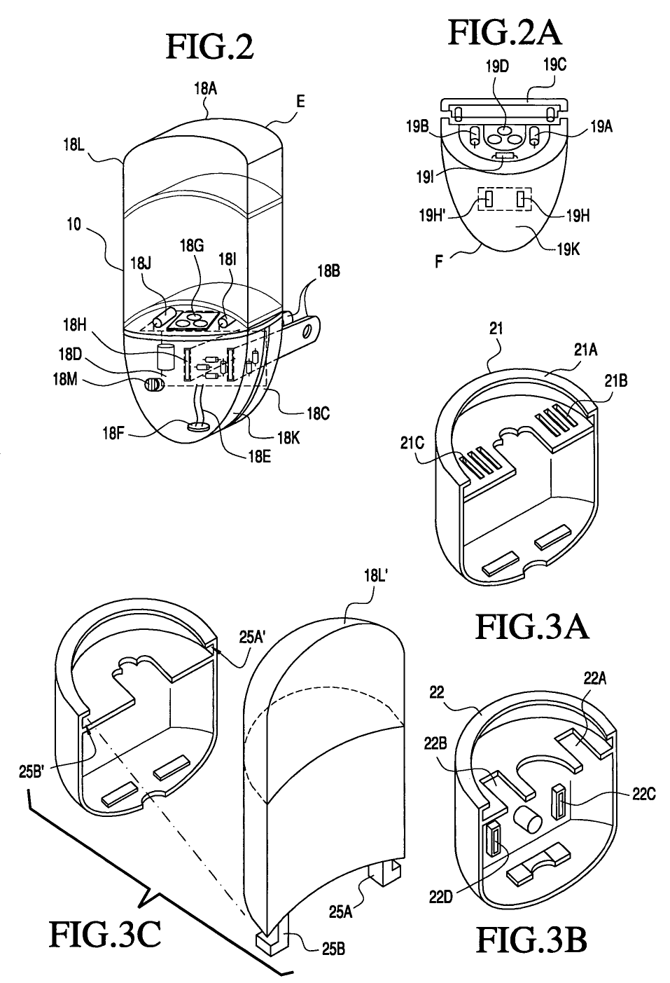

From FIG. 2, the night light (E) as current invention have the upper housing (18L) and front base (18K) and back base (18C). A multiple sealed LED units (18G) are disposed within the housing and connected with circuit means (18D) to emit the light beam to upper housing (18L) and to be seen by viewer. The light arrangement is for in-directly light beam to be seen by viewer. The circuit means (18D) have build-in plurality of functions as the earlier discussion from function (f1) to (f11). The night light have the 1^{st} function performance while the prong means (18B) connected with power source (not shown). A switch means (18M) on the proper location on the front base (18K) or (18C) to allow people can be selected the next function from the plurality of functions build inside of the said circuit means (18D). At least one of the heater means (181) (18J) are disposed within the front and back base adjacent to the bottom of the top housing (18K) to offer sufficient heat to the top housing (18L) to cause the medium means (not shown) and miniature means (not shown) with movement basing on the heat. The heat means also have alternative arrangement while use the PCB type as earlier discussion.

From the embodiment (F), disclosure the other view to see the arrangement of the heat means (19A) (19B) (19I) on the upper location and adjacent to the top housing bottom. The multiple LEDs (19D) are arranged on the center location of the base to offer the light to the top hosing for best coverage of the limited LED emitting angle. The prong means (19H) are well install on the back base (19C) to get power source.

From the FIG. 3A, can see the apertures or opening or slot arrangement on the front base of the embodiment (F) to allow the heat means's heat can be as much as possible. From the FIG. 3B, with the big opening or cut-out arrange to get same function with the FIG. 3A. From FIG. 3C, disclosure the assembly design for the top housing (18L′) with the front base (18K) by the two “L” shape plastic bolts (25A) (25B) into the front base's slot (25A′) (25B′) with recess arrangement after assembly.

From the FIG. 4, disclosure the details assembly of the 1^{st} embodiment which has the top housing (28) and front base (18A) and back base (28C) and top housing back plate (28B). the front base (28A) assembly with back base (28C) by a screw (28N). The top housing (28) slide into the slots of the front base as FIG. 3C details. The top housing (28) have its back plate (28B) so can allow the medium means and miniature means can well install inside and sealed by safety procedure to prevent the inner medium means have leakage problem. The heat means (28E) (28E′) disposed within the front base and back base with higher position so can let heat make the medium means with movement. The circuit means and switch means disposed within the front base and back base to drive the said LEDs (28D) with plurality light functions and can be change to the next function while operate the switch means from the outside suface of the said night light.

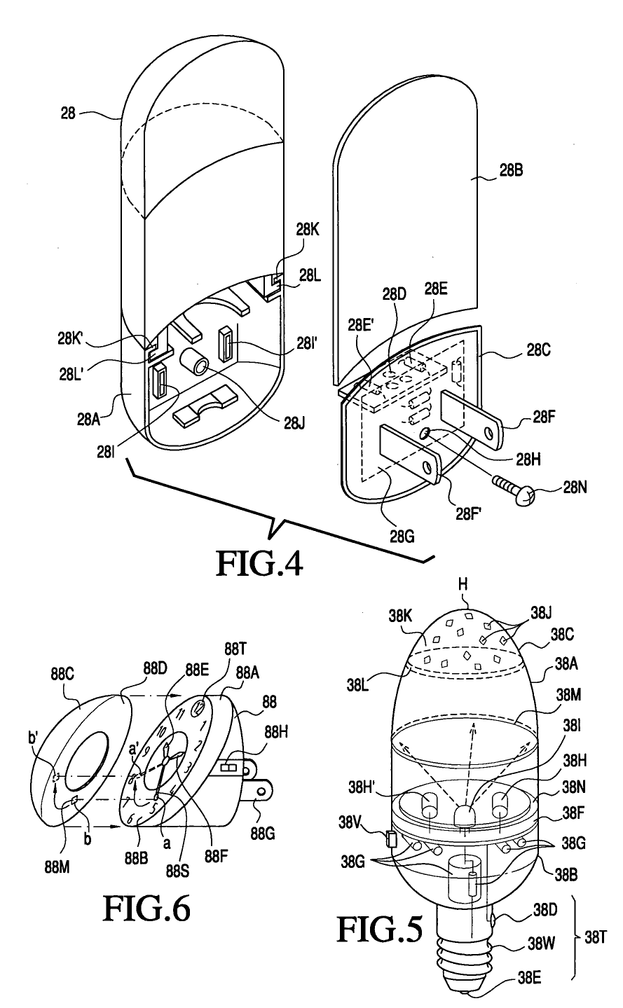

From the FIG. 5, disclosure the LED night light which fit into all conventional bulb holder (not shown). The bulb shape embodiment (H) have the upper portion (38C) have medium means (38K) and miniatures means (38J) disposed within with the divider (38L) to make the upper portion to be separated with the rest of the space of the top housing (38A). The upper portion (38C) space can be larger or smaller depend on the market requirement as long as to make the proper divider to lower or upper location can easily to get. The top housing (38A) connect with lower housing (38B) by conventional skill such as ultrasonic, chemical glue, solvent to make the top housing and lower housing to get together solid. The lower housing (38B) have circuit means (38F), light means (381), heat means (38H) (38H′), electric components (38G) disposed within with proper sealing means to fix on location. The circuit means (38F) connect with the screw base's (38W) electrodes (38D) (38E) to get the electric power source. At least one switch means (38V) on the night light outside surface to allow people to operate to make function-change from 1^{st} to the next function while needed.

This bulb shape embodiment can replace all current conventional market gas filled bulb including the medium means and miniature means while the LED bulb's screw base (38T) connected with the night light bulb receiving socket (not shown). The LED bulb will have the light emit out while the electricity delivery from the night light's prong means to the LED bulb which passing though the night light receiving socket→the bulb's screw base's electrodes→the circuit means→to LED light means. The bulb shape LED light has a switch means to make function-change from the 1^{st} function performance to the next function which may selected from the earlier discussion functions from (f1) to (f11) of possibility 11×11 assortments.

The bulb shape LED light for night light application will be simple replacement by any people from kids to aged with most safety procedures. It is also very good for function selection by operating the said switch means from the plurality functions from IC chips.

From the FIG. 6, further incorporated with other device for current invention. The LED night light with liquid optics medium has the top housing (88C) and the lower housing (88) which have the clock movement (88A) with hour arm (88E) and minute arm (88F) and second arm (88S) to show the time on the dial face (88B). The dial face with 1 to 12 marking which can be use LED light means (88T) to make it illumination with the 2^{nd} colors. The rest of the marking can have the 1^{st} color for illumination. The second arm (88S) with magnetic means on the tip which will make the magnetic miniature means (88M) to follow the second arms movement and make a circle movement response the second arm's movement per second. The preferred heat means can be optional use for this application because the magnetic means for the miniature means (88M) and second arm (88S) is very eye-catching.

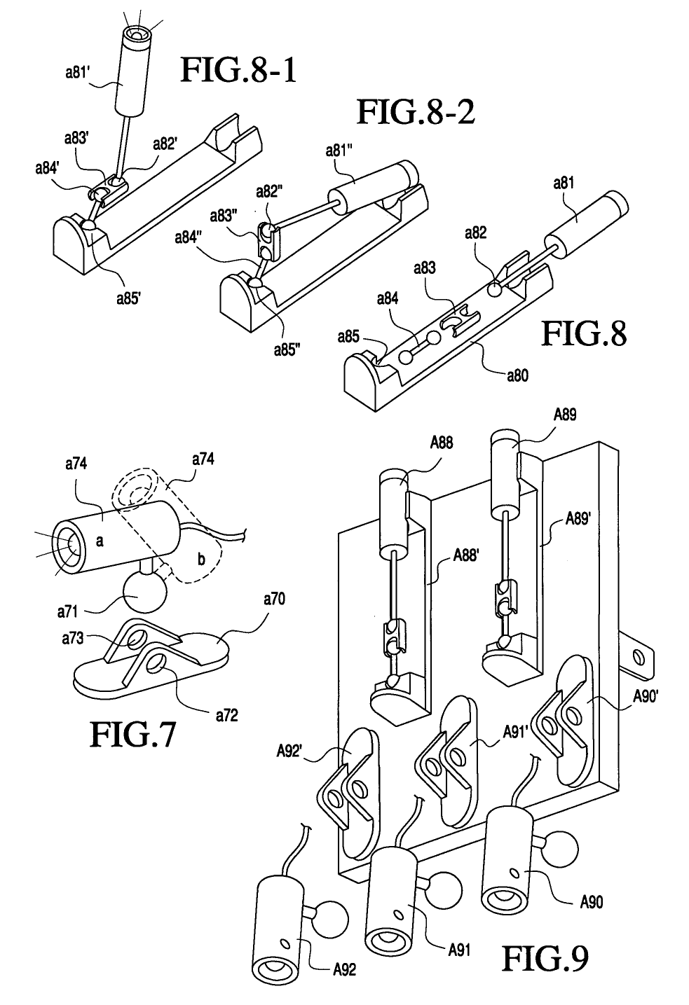

From FIG. 7, disclosure the preferred embodiment has the LED light kits have the base (a70) and adjustable orientation light tube. The light tube (a74) has the ball joint base (a71) which clipper into the holes (A72) and (A73) to allow the position to change from (a) to (b) so can get the light tube (a74) to different orientation.

From FIG. 8, disclosure the up-grade embodiment has the 360 degree of orientation changeable features while incorporated plurality of the said ball joint means as (a82), (a84) the ball joint means clipper into the two ball end bar (a83) to form the 360 degree of adjustable orientation means. so the light can become the orientation as FIG. (8-1) and FIG. (8-2) while the plurality of ball joint means and ball end bar combinations are applied so the said LED night light can have features to emit the light to any directions (FIG. 9) with preferred circuit means to make the plurality of the said LED light kits with desired light functions which as the earlier discussion of (f1) to (f12) such as all steady on of LED light kits (A90) (A91) (A92) (A88) (A89). This also can make a good light device to assembly complicated computer wires under the table with this orientation light to help as working lamp functions. It also preferred to incorporated with sound sensor selected from one of the said control means to make the light with sequential flashing as the Disco light for party use. This will be the most low end cost for party application for indoor or outdoor activity as long as enough extension cords.

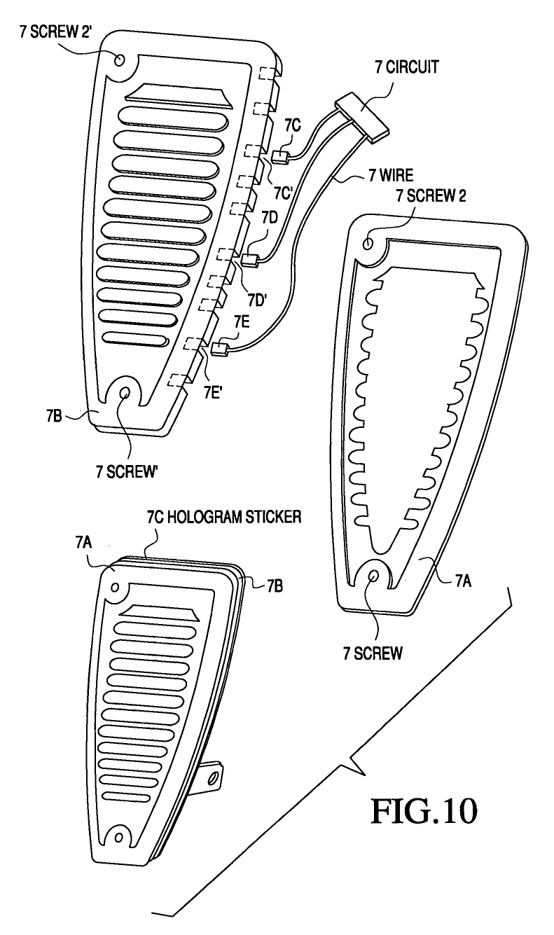

From FIG. 10, can see a preferred embodiment has a rigid optics medium (7B) underneath a front stencil means (7A) to form a very nice quality LED night light. The LED night light (700) with rigid optics medium (7B) including:
At least one of prong means (701) build in the said night light and supply the electricity to the light mean (7C) (7D) (7E) while the said prong means are connected with the power source.
At least one of the light means (7C) (7D) (7E) which be selected from the group combination from dice, chip, sealed unit of the said LED as light source with certain range of the visible wavelength to viewers incorporated the related circuit means to offer illumination under predetermined time, functions, brightness, colors and duration.

At least one of the rigid medium means (7B) which may selected from group combination from (m2) solid plastic body, (m3) light passing though material, or (m4) any medium means which can cause the light have traveling within, reflective, diffusion, optics properties may incorporate with the said LED light source to increase the value, appearance, accent of the said night light.

At least one of cosmetic media (7C) adjacent to the said rigid optics means which may be any material such as (bg 1) shell, (bg 2) leaves, (bg 3) dry flower, (bg 4) potpourri, (bg 5) flower, (bg 6) plastic piece, (bg 7) floating stuff, (bg 8) fish, (bg 9) animals, (bg 10) smiling face, (bg 11) metal piece, (bg 12) paper piece, (bg 13) wood piece, (bg 14) seed, (bg 15) boat, (bg 16)snow flake, (bg 17) tree, or (bg 18) hologram piece or (bg 19) any material with designed shape and colors with design, indicia, drawing, color, painting, coating which available to put behind or underneath or adjacent to the medium means to increase the value appearance to let the medium means look like conventional gift items which including a scene inside such as seasonal water ball, artificial aquarium, kids toy with sealed liquid applications. This is the majority LED light kits problem because the ugly appearance so the consumer do not like to buy the LED light if the said night light only can see the light beam at night time but can not have cosmetic appearance on surface, it is very bad for sales on market place. The current invention have this very important cosmetic means

At least one of the stencil means (7A) which made of the (ml) plastic (m2) metal (m3) aluminum piece (m4) wood (m5) textile (m6) pottery (m6) porcelain in front of the rigid medium means to make the pretty appearance and connected with proper housing member for the said night light by fasten means. This also other very important appearance value parts for the sales purpose requirement.

The LED night light with rigid optics medium may incorporated the proper circuit means (7 circuit) through the wires (7 wires) which can have desired function selected from the group combination from (f1) steady, (f2) chasing, (f3) random, (f4) fade in and fade out, (f5) sequential, (f6) pair flashing, (f7) scan, (f8) color mixed, (f9) color changing, (f10) all flashing or (f11) any combinations for all light effects from market place available. All these functions can be designed under predetermined time, duration, orders, and function as requirement. These circuit means can make the said the light means (7C) (7D) (7E) with a splendid light effects though the rigid medium and hologram cosmetic means. The said hologram cosmetic means also have laser grating features so also can create some other optics properties to increase the light value of the said night light.

The improvement including:

The said night light with preferred shape, thickness, configuration for rigid optics medium means with desired light beam from LED passing though the said liquid optics medium means, and do not need to incorporated at least one of heater means to make the medium means and miniature means to change position by heat created from heater means.

The said night light with 1^{st} function while the prong means connected with power source and the function can be changed to next function from group of functions though switch means operation.

The preferred embodiment is to explain the spirit of the current invention but should not limited to the full range of current invention for limited light means to pass though the fiber optics which arranged on the main objects to let viewer to see the certain range of the visible wavelength of the light.

1. The LED night light with liquid medium including:
At least one of prong means build in the said night light and supply the electricity to the light mean(s) while the said prong means are connected with the power source.
At least one of the light means which be selected from the group combination from dice, chip, sealed unit of the said LED as light source with certain range of the visible wavelength to viewers incorporated the related circuit means to offer illumination under predetermined time, functions, brightness, colors and duration.
At least one of the medium means which may selected from group combination from (m1) Oil, (m2) solid plastic body, (m3) light passing though material, or (m4) wax, or (m5) any medium means which can cause the light have reflective, diffusion, optics properties may incorporate with the said LED light source to increase the value, appearance, accent of the said night light.
At least one of the miniatures means are within the said medium media which may be any material such as (mi 1) shell, (mi 2) leaves, (mi 3) dry flower, (mi 4) potpourri, (mi 5) flower, (mi 6) plastic piece, (mi 7) floating stuff, (mi 8) fish, (mi 9) animals, (mi 10) smiling face, (mi 11) metal piece, (mi 12) paper piece, (mi 13) wood piece, (mi 14) seed, (mi 15) boat, (mi 16)snow flake, (mi 17)tree, or (mi 18) any material with designed shape and colors with design, indicia, drawing, color, painting, coating which available to put within the medium means to increase the value appearance to let the medium means look like conventional gift items which including a scene inside such as seasonal water ball, artificial aquarium, kids toy with sealed liquid applications.
The LED night light with liquid optics medium may incorporated the proper circuit means which can have desired function selected from the group combination from (f1) steady, (f2) chasing, (f3) random, (f4) fade in and fade out, (f5) sequential, (f6) pair flashing, (f7) scan, (f8) color mixed, (f9) color changing, (f10) all flashing or (f11) any combinations for all light effects from market place available. All these functions can be designed under predetermined time, duration, orders, and function as requirement.
The improvement including:
The said night light with preferred shape, thickness, configuration for liquid optics medium means with desired light beam from LED passing though the said liquid optics medium means, and incorporated at least one of heater means to make the medium means and miniature means to change position by heat created from heater means.
The said night light with 1^{st} function while the prong means connected with power source and the function can be changed to next function from group of functions though switch means operation.

2. The LED night light with liquid medium as claim 1, the said night light futher incorporated with at least one of the device which may selected from (o1) motor, (o2) movement, (o3) filter device, (o4) IC chips with desired functions, (o5) sensor, (o6) rotating filter, (o7) magnetic piece and metal pieces, (o8) sound receiver device to make preferable light effects and functions.

3. The LED night light with optics medium as claim 1, the said night light have switch means to make function selection from multiple or group of the said functions.

4. The LED night light with optics medium as claim 1, the prong means connect with circuit means by any combination of the resilient conductive means, conductive wires, conductive metal piece, conductive soldering paste with conventional soldering, snapping, clipping means to delivery the electricity from prong means to circuit means.

5. The LED night light with optics medium as claim 1, the said night light having the ground prong means.

6. The LED night light with optics medium as claim 1, the circuit means connect with light means by any combination of the resilient conductive means, conductive wires, conductive metal piece, conductive soldering paste with conventional soldering, snapping, clipping means to delivery the electricity from circuit means to light means.

7. A night light including:
At least one of prong means disposed within the housing to get power source to circuit means.
At least one of light source which has multiple of patterns as light means connect with circuit means.
At least one of circuit means has integrated circuit (IC) chip build-in with plurality of light functions can be selected from switch means.
The said night light will have light beam emit out to viewer while the prong means are connect to the power source.
At least one switch means to make function selection from plurality of functions.
The improvement:
The said night light with 1^{st} function while the prong means connected with power source and the function can be changed to next function from plurality of functions from circuit means though switch means operation.

8. The night light of claim 8, wherein the light source is an LED.

9. A LED bulb for the night light of claim 7, including:
At least one of bulb has screw base with electrode contactors to fit into receiving socket of the conventional night light.
At least one piece of LED light means which has Multiple of patterns as light means connect with circuit means disposed within the said bulb.
At least one of the circuit means has integrated circuit (IC) chip build-in with plurality of light functions can be selected from switch means.
The said bulb have light beam emit out to viewer while the prong means of said the night light are connect to the power source and said bulb install on the receiving socket with electricity delivery from prong means to light means.
At least one switch means to make function selection from plurality of functions.
The improvement:
The said night light with 1^{st} function while the said bulb connected with power source and the function can be changed to next function from plurality of functions from circuit means though switch means operation.

10. A night light as claimed in claim 8 including:
At least one of LED light kits which has orientation changeable as light means connect with circuit means and prong means,
The improvement:
The said at least one of LED light kits disposed within the said night light to make multiple light beams emit direction with changeable orientation properties.

11. The LED night light with rigid optics medium including:
At least one of prong means build in the said night light and supply the electricity to the light mean(s) while the said prong means are connected with the power source.
At least one of the light means which be selected from the group combination from dice, chip, sealed unit of the said LED as light source with certain range of the visible wavelength to viewers incorporated the related circuit means to offer illumination under predetermined time, functions, brightness, colors and duration.
At least one of the medium means which may selected from group combination from (m2) solid plastic body, (m3) light passing though material, or (m4) any medium means which can cause the light have traveling within, reflective, diffusion, optics properties may incorporate with the said LED light source to increase the value, appearance, accent of the said night light.
At least one of cosmetic means adjacent to rigid optics means which may be any material such as (bg 1) shell, (bg 2) leaves, (bg 3) dry flower, (bg 4) potpourri, (bg 5) flower, (bg 6) plastic piece, (bg 7) floating stuff, (bg 8) fish, (bg 9) animals, (bg 10) smiling face, (bg 11) metal piece, (bg 12) paper piece, (bg 13) wood piece, (bg 14) seed, (bg 15) boat, (bg 16)snow flake, (bg 17)tree, or (bg 18) hologram piece or (bg 19) any material with designed shape and colors with design, indicia, drawing, color, painting, coating which available to put behind or underneath or adjacent the medium means to increase the value appearance to let the medium means look like conventional gift items which including a scene inside such as seasonal water ball, artificial aquarium, kids toy with sealed liquid applications.
At least one of the stencil means which made of the (m1) plastic (m2) metal (m3) aluminum piece (m4) wood (m5) textile (m6) pottery (m6) porcelain in front of the rigid medium means to make the pretty appearance and connected with proper housing member for the said night light by fasten means.
The LED night light with rigid optics medium may incorporated the proper circuit means which can have desired function selected from the group combination from (f1) steady, (f2) chasing, (f3) random, (f4) fade in and fade out, (f5) sequential, (f6) pair flashing, (f7) scan, (f8) color mixed, (f9) color changing, (f10) all flashing or (f11) any combinations for all light effects from market place available. All these functions can be designed under predetermined time, duration, orders, and function as requirement.
The improvement including:
The said night light with preferred shape, thickness, configuration for rigid optics medium means with desired light beam from LED passing though the said rigid optics medium means to viewer.
The said night light with 1^{st} function while the prong means connected with power source and the function can be changed to next function from group of functions though switch means operation.
